(19) United States
(12) Patent Application Publication
(10) Pub. No.: US 2021/0138870 A1
(43) Pub. Date: May 13, 2021

(54) VALVE

(71) Applicant: Mahle International GmbH, Stuttgart (DE)

(72) Inventors: Richard GOCE, Stuttgart (DE); Frank HUBER, Leonberg (DE)

(73) Assignee: Mahle International GmbH, Stuttgart (DE)

(21) Appl. No.: 17/093,496

(22) Filed: Nov. 9, 2020

(30) Foreign Application Priority Data
Nov. 8, 2019 (DE) 10 2019 217 319.5

(51) Int. Cl. B60H 1/00

(52) U.S. Cl. CPC B60H 1/00485

(57) ABSTRACT

A valve, in particular for an air duct of an air conditioning system of a motor vehicle, having a body and having at least two bearing couplings for bearing-mounted arrangement of the valve, wherein the body has a planar extent with a first side face and with an opposite second side face, wherein the first side face is convex in design.

This nonprovisional application claims priority under 35 U.S.C. § 119(a) to German Patent Application No. 10 2019 217 319.5, which was filed in Germany on Nov. 8, 2019, and which is herein incorporated by reference.

### BACKGROUND OF THE INVENTION

### Field of the Invention

The present invention relates to a valve, in particular for an air duct of an air conditioning system of a motor vehicle.

### Description of the Background Art

Air conditioning systems for motor vehicles have air ducts in which valves are arranged that control the airflow through the valve. Such valves can also be used for air distribution and for controlling the volume of through-flowing air. In this case, air flows against or over the valve, with the result that substantial aerodynamic forces act on the valve.

So that the valve closes tightly, for example, it must make full-area contact with the sealing surfaces provided, for which purpose the valve as a whole must be designed to be relatively stable and torsionally rigid. Consequently, special demands are made of the torsional and bending stiffness of the valve in order to prevent high forces acting on the valve from adversely affecting the sealing characteristics and the air controlling characteristics.

### SUMMARY OF THE INVENTION

It is therefore an object of the present invention to provide a valve that has improved torsional and bending stiffness.

In an exemplary embodiment of the invention a valve, in particular for an air duct of an air conditioning system of a motor vehicle, having a body and having at least two bearing couplings for bearing-mounted arrangement of the valve is provided, wherein the body has a planar extent with a first side face and with an opposite second side face, characterized in that the first side face is convex in design. A sort of airfoil profile is created by the design of the side faces, so that the design of the body achieves improved torsional and bending stiffness. As a result, the valve as a whole becomes markedly stiffer or can, if applicable, be made lighter with the same stiffness, which saves material and hence costs.

In this context it is also advantageous when the second side face is essentially flat in design. As a result, a semi-convex design of the body can be produced, which creates a markedly stiffer structure.

It is also useful when the second side face is essentially concave in design. It is also advantageous when the second side face is essentially convex in design. Such designs likewise permit a markedly stiffer structure.

It is also advantageous when projecting ribs are provided on the second side face. These ribs increase stiffness, which is to say the torsional stiffness and the bending stiffness, of the structure of the valve. In this case, the ribs are preferably arranged in patterns so as to be able to achieve an improvement in stiffness.

It is advantageous when indentations are provided on the first side face. These indentations are advantageously formed in locations where ribs are formed on the second side face. The indentations can also be provided elsewhere, however, in order to achieve additional stiffening of the valve.

It is also advantageous when the indentations of the first side face correspond with projecting ribs of the second side face. A simple stiffening of the valve with low weight can be achieved in this way.

It is also useful when a shape of the indentations on the first side face corresponds with a shape of projecting ribs on the second side face. In this way, a stable design is achieved as well.

In an example, it is also advantageous when the body is essentially rectangular in design, in a view perpendicular to one of the side faces, and has an essentially full-perimeter sealing lip. In this way, a form is achieved that is compatible with an advantageous air duct, wherein the essentially full-perimeter sealing lip brings about a reliable seal when in contact with a sealing surface of the air duct.

It is also useful when the sealing lip projects in a direction away from the first side face at a first long side of the body and the sealing lip projects in a direction away from the second side face at a second long side of the body. Good contact is achieved as a result, wherein the particular orientation of the sealing lip is provided in the direction of rotation of the valve, which brings about reliable contact of the sealing lip.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a valve according to the invention with a first side face;

FIG. 2 is a perspective view of the valve according to the invention with the second side face;

FIG. 3 is a sectional representation through the valve from FIGS. 1 and 2; and

FIG. 4 is a representation through the valve from FIGS. 1 and 2.

### DETAILED DESCRIPTION

FIGS. 1 and 2 each show a perspective view of an exemplary embodiment of a valve 1 according to the invention. The valve 1 is an airflow control element, in particular for an air duct of an air conditioning system of a motor vehicle. The valve 1 can be used as a control valve for the flow through an air duct, as a mixing valve, etc.

The valve 1 has a body 2, on which at least two bearing couplings 3 are provided in order to hold the valve 1 in a supported manner, for example at bearing positions of the air duct, for bearing-mounted arrangement of the valve 1.

The body 2 in this case has a planar extent, which is approximately rectangular in the exemplary embodiment shown, when considered in a view perpendicular to one of the side faces 4, 5 of the valve 1.

Moreover, it is also evident that an essentially full-perimeter sealing lip 6, which projects from the body 2, is provided on the edge of the body 2.

The sealing lip 6 in this case is designed in the exemplary embodiment shown such that it projects in a direction away from the first side face 4 at a first long side 9 of the body 2, and the sealing lip 6 projects in a direction away from the second side face 5 at a second long side 10 of the body 2.

In addition, the body 2 has a first side face 4 and an opposite second side face 5, which form the planar side faces of the body 2.

It can be seen in FIGS. 1 and 3 that the first side face 4 is convex in design, or in other words has a bulging shape.

The second side face 5 is essentially flat in design, as FIGS. 2 and 4 show. Alternatively, the second side face 5 could also be essentially convex in design or the second side face 5 could also be essentially concave in design.

As a result, a profile of the body 2 is achieved that resembles a sort of airfoil profile, so that the design of the body 2 achieves improved torsional and bending stiffness. As a result, the valve 1 as a whole becomes significantly stiffer or can, if applicable, be made lighter with the same stiffness, which saves material and hence costs.

The figures also show that projecting ribs 7 are provided on the second side face 5. These ribs 7 protrude from the second side face 5 in an angled pattern and provide further improved stiffness of the valve 1.

The ribs 7 are created in this case as two rows of paired ribs that repeat side by side in a v-shape, wherein two ribs 7, which are arranged between the bearing couplings 3 and approximately parallel to the axis of rotation, are provided between the two rows of the v-shaped rib pairs.

Moreover, it is also evident in FIG. 1 that indentations 8 are provided on the first side face 4. These indentations 8 correspond with projecting ribs on the second side face 5. The indentations 8 in this case are also created as two rows of paired indentations that repeat side by side in a v-shape.

It is evident here that a shape of the indentations 8 on the first side face 4 corresponds with a shape of projecting ribs 7 on the second side face 5.

The valve can advantageously be designed as a flap valve with an axis of rotation essentially on one long side of the valve, or as a butterfly valve with an axis of rotation approximately in the center of the body and parallel to a long side.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A valve for an air duct of an air conditioning system of a motor vehicle, the valve comprising:
a body; and
at least two bearing couplings for bearing-mounted arrangement of the valve,
wherein the body has a planar extent with a first side face and with an opposite second side face,
and wherein the first side face is convex.

2. The valve according to claim 1, wherein the second side face is essentially flat in design.

3. The valve according to claim 1, wherein the second side face is essentially convex in design.

4. The valve according to claim 1, wherein the second side face is essentially concave in design.

5. The valve according to claim 1, wherein projecting ribs are provided on the second side face.

6. The valve according to claim 1, wherein indentations are provided on the first side face.

7. The valve according to claim 1, wherein the indentations of the first side face correspond with projecting ribs of the second side face.

8. The valve according to claim 1, wherein a shape of the indentations on the first side face corresponds with a shape of projecting ribs on the second side face.

9. The valve according to claim 1, wherein the body is essentially rectangular in design, in a view perpendicular to one of the first or second side faces, and has an essentially full-perimeter sealing lip (6).

10. The valve according to claim 1, wherein the sealing lip projects in a direction away from the first side face at a first long side of the body, and the sealing lip projects in a direction away from the second side face at a second long side of the body.
